(19) United States
(12) Patent Application Publication
(10) Pub. No.: US 2012/0054102 A1
(43) Pub. Date: Mar. 1, 2012

(54) Method & System for Providing Payments Over A Wireless Connection

(75) Inventors: David Schwartz, San Francisco, CA (US); Matt Dimmick, Sunnyvale, CA (US)

(73) Assignee: Obopay, Inc., Redwood City, CA (US)

(21) Appl. No.: 13/219,304

(22) Filed: Aug. 26, 2011

Related U.S. Application Data
(60) Provisional application No. 61/377,455, filed on Aug. 26, 2010.

(51) Int. Cl. G06Q 40/00

(52) U.S. Cl. 705/44

(57) ABSTRACT

The present invention relates to a method and system for providing payments over a wireless connection. Instant messaging services—such as mobile text messaging—addressed to a command interpretation and processing system are utilized in conjunction with a checkout procedure on a mobile device to enable a user making a payment to simply define and confirm the amount of his or her payment, and the recipient. The checkout procedure can be completed with SMS, Mobile Web, Mobile App or IVR implementation. Previously Registered as well as new unregistered users are supported. The payer, through his or her mobile device, interacts with a system for managing mobile payment transactions that validates the sender and recipient of the funds, the presence of funds in a transacting account and other fraud management and authentication checks, and effects a settlement. The Sender may chose a variety of funding sources to fund the transaction, while the recipient can receive the funds on a debit or credit account, or immediately in a demand deposit account of their choice. In one embodiment of the present invention the system is used to pay for purchases of goods and services. In another embodiment of the present invention, the system is use to provide donations to charities.

### RELATED APPLICATION

This application claims the benefit of U.S. Pat. Appn. Ser. No. 61/377,455, filed Aug. 26, 2010, having the same title and same assignee as the present application, and is incorporated herein by reference in its entirety. In addition, this application claims the benefit of U.S. patent application Ser. No. 11/694,747, filed Mar. 30, 2007; Ser. No. 11/694,881, filed Mar. 30, 2007; Ser. No. 11/694,906, filed Mar. 30, 2007; Ser. No. 11/694,903, filed Mar. 30, 2007; Ser. No. 11/694,887, filed Mar. 30, 2007; Ser. No. 11/694,894, filed Mar. 30, 2007; Ser. No. 11/694,895, filed Mar. 30, 2007; Ser. No. 11/694,896, filed Mar. 30, 2007; Ser. No. 11/694,891, filed Mar. 30, 2007; and Ser. No. 12/470,482, filed May 21, 2009; and, through them, U.S. patent applications 60/744,013, filed Mar. 30, 2006; 60/744,930, filed Apr. 15, 2006; and 60/870,484, filed Dec. 18, 2006, In addition, this application claims the benefit of U.S. patent application Ser. No. 12/405,203, filed Mar. 16, 2009, patent application Ser. No. 12/555,772, filed Sep. 8, 2009; patent application Ser. No. 13/167,622, filed Jun. 23, 2011; patent application Ser. No. 13/219,304; as well as provisional application Ser. Nos. 60/036,866, filed Mar. 14, 2008; 61/060,118, filed Jun. 9, 2008; Ser. No. 61/095,290, filed Sep. 8, 2008; Ser. No. 61/095,292, filed Sep. 8, 2008; Ser. No. 61/357,949, filed Jun. 23, 2010, and Ser. No. 61/377,455, filed Aug. 26, 2010. All of the foregoing applications are incorporated herein by reference along with all other references cited in this application.

### FIELD OF THE INVENTION

The present invention relates generally to methods and techniques for managing value transfers from a sender to a recipient, and more particularly relates to such methods and techniques where the value exchange can be a donation, payment or other transfer where the nature of the transfer and the recipient are readily entered from a mobile device using either a code character string or a command character string. The code character string can include various default attributes including commands and identification of a recipient. A command string can include various default attributes. The defaults can be modified by the user as desired for a particular transaction. The Sender may chose a variety of funding sources to fund the transaction, while the recipient can receive the funds on a debit or credit account, or immediately in a demand deposit account of their choice. In one embodiment of the present invention the system is used to pay for purchases of goods and services. In another embodiment of the present invention, the system is use to provide donations to charities.

### BACKGROUND OF THE INVENTION

Increasingly consumers are receptive to using mobile phones to conduct financial transactions. This was well demonstrated during several recent humanitarian crises where charities such as the American Red Cross were able to collect funds through mobile messaging. However the solutions in place have a number of drawbacks. First they are limited either to carrier billing, that is funds provided to the recipients are applied to a mobile bill or are required to first become part of a closed loop system such as PayPal, neither of which is desirable for the majority of consumers. Second these solution require establishing SMS short codes for every campaign which is time consuming process only offered by few providers. Third, current solutions only allow for fixed amounts, $5 or $10 for instance. Lastly current solutions result in funds being withheld from the recipient for extended periods of time (up to 45 days or more for carrier billing and in excess of a week for a typical closed loop system) as service providers wait for the phone bill or closed loop account to be settled. Lastly the receiving entities presently do not have access to Sender information which impacts their ability to market and develop their activity. What is therefore needed to deliver a solution viable for the growing number of consumers willing to complete financial transactions on a mobile phone is a solution that provides access to a broader range of recipients, for any sender-selected amount, with access to multiple funding sources for the sender, and rapid transfer of the funds. Once in place such a solution can be used not only to donate money, but also to pay for goods and services from large and small merchants. This solution must be accessible to a broad range of cell phones and subscribers, simple to utilize, yet secure and auditable. This solution must also provide unique means for identifying and reaching Senders. Because the amounts involved may be small it also must be cost efficient. While PayPal has provided elements of a solution in the past, it is neither immediate nor open to any sender without prior registration. Hence a solution that is accessible to all mobile subscribers regardless of their participation to a specific payment scheme is still needed and such a solution must be able to connect to a wide range of payment networks to ensure rapid, safe and convenient processing of transactions from and to a variety of accounts. Accordingly, the following embodiments and exemplary descriptions of the present invention are disclosed.

### SUMMARY OF THE INVENTION

The present invention provides a system and method for managing forms of electronic value exchange, where the value exchange can be a donation, payment or other transfer. The value exchange can be readily initiated from a mobile device using either a code character string or a command character string, and allows the nature of the transfer and the recipient to be readily entered from such a mobile device.

In an embodiment, the code character string includes various default attributes including commands and identification of a recipient. A command string can include various default attributes. The defaults can be modified by the user as desired for a particular transaction. A variety of funding sources can be selected by the sender to fund the transaction.

### BRIEF DESCRIPTION OF THE FIGURES

FIG. 1 describes a payment processing platform enabling connectivity across different networks and the management of mobile payment transactions.

FIG. 2 describes an embodiment of the topology of the overall solution of the present invention, and the relationship of the various parties, including such participants as the mobile operators and financial institutions.

FIG. 3 illustrates a functional implementation of an embodiment of the system of the present invention

FIG. 4 illustrates an embodiment of a process for servicing a payment request in accordance with the present invention.

FIG. 5 describes an exemplary embodiment of the overall set of activities from the various participants starting with the registration of a transaction program and ending with a transaction fully completed and funds transferred.

FIG. 6 Describes an exemplary logical flow governing a transaction starting from a consumer's decision to send money to a recipient and ending with the successful or unsuccessful processing of the transaction

FIG. 7 details the steps associated with sending, receiving and processing an exemplary SMS command to initiate a transaction.

FIG. 8 details the steps associated with processing an exemplary checkout in the event of a non-registered user, or an undefined amount.

FIG. 9 shows an exemplary embodiment of the mobile phone messages for a registered user.

FIG. 10 shows an exemplary embodiment of the mobile phone messages and initiation of a checkout page for a non-registered user.

FIG. 11 shows an exemplary embodiment of the checkout procedure for mobile web or mobile application cases.

### DETAILED DESCRIPTION OF THE INVENTION

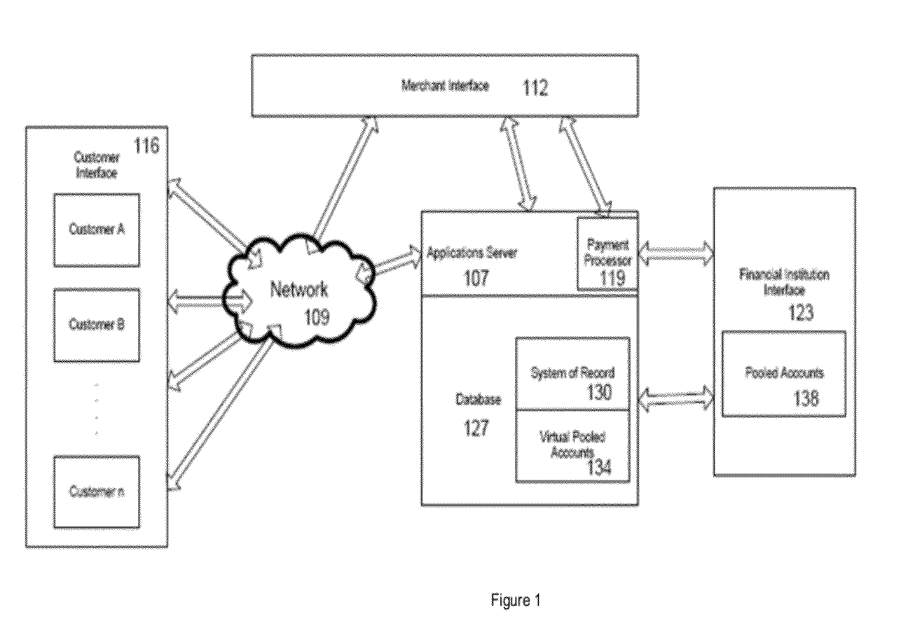

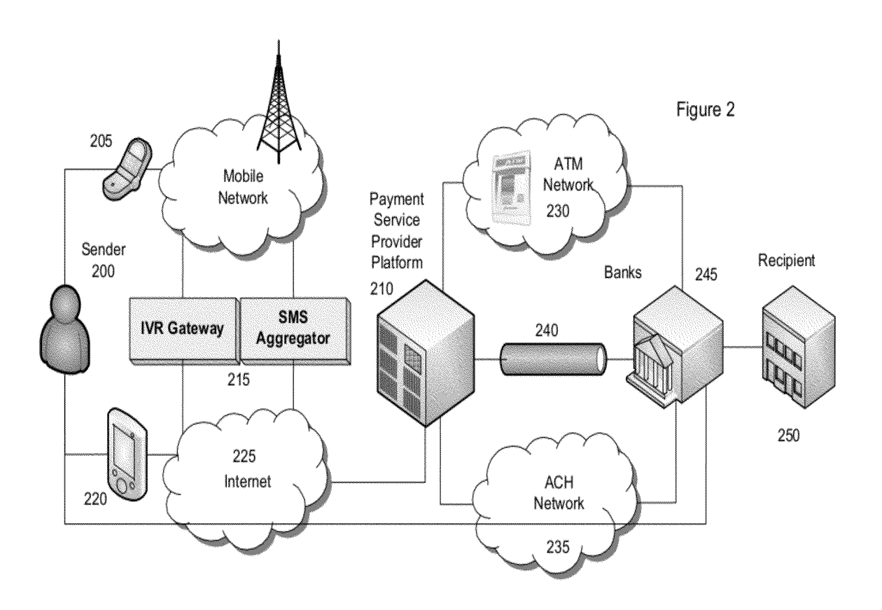

Referring first to FIGS. 1 and 2, the present invention comprises, in one aspect, a message-processing platform for enabling the sending, receipt and handling of payment and associated commands, and in another aspect an electronic payment platform and service that provides a fast, easy way for users of mobile and other networked devices to conduct electronic financial transactions between and among clients and servers that are connected to a wireless network. Thus, with particular reference to FIG. 2, the present invention enables Senders 200 using a messaging device 205 to send orders for payments and money transfers (and associated activities) to charities, merchants, institutions, individuals, or anyone else, substantially anywhere, anytime and on a real time basis via a payment service provider platform 210. In at least some embodiments, the funds are ‘good’ funds, meaning that those funds, once received, are immediately accessible by the recipient without limitation due to any pending settlement processes. In some embodiments of the present invention only the sender of the funds transferred as part of a transaction need to be registered on the platform. The platform interfaces with mobile devices through a mobile network 215 employing any suitable communications services as SMS, email, IVR, IM, web, etc., shown generally at 215, and using programming platforms including but not limited to J2ME and Brew, together with network/transport layer protocols including but not limited to WAP, USSD and IP. Smartphones and other similar devices 220 can communicate with the platform 210 directly over the internet 225.

In an embodiment, the electronic payment platform of the invention is comprised of a plurality of software modules operating on a plurality of servers accessible through secure network connections and protected from intrusion with any suitable methods such as firewalls, user and machine authentication, and data encryption. In one embodiment of the present invention the electronic payment platform includes a transaction gateway, receiving and posting for processing on a real time basis transactions from mobile networks or SMS aggregators. The electronic payment platform includes appropriate software modules as required to complete Sender registration and management, Receiving entities registrations, transaction management, fraud management, compliance management, network and service level management, customer service management, settlement management, and financial networks connectors management. Financial networks supported include but are not limited to ATM networks 230, Automatic Clearing House (ACH) connections 235, and direct secure integration 240 into the hosts of participating financial institutions 245, whereby a recipient 250 receives the transmitted funds or other value exchange. The electronic payment platform can be implemented on a single server or a plurality of servers located in a single location or geographically dispersed.

In an embodiment, the system of the present invention is comprised of a series of functional modules for processing a payment-related command received over a messaging interface, and processing the associated payment transaction.

In an embodiment, the Sender uses a wireless or wired device able to connect through a messaging interface to a point of access defined by an electronic payment service provider. The messaging system is substantially real time and can operate over any suitable platforms such as SMS, MMS, Instant Messaging or Peer-to-Peer messaging. The point of access is defined by a specific address characteristic of the messaging system used, such as a phone number, a short code or an instant messaging id.

Thus, still referring to FIGS. 1 and 2, FIG. 1 shows a block diagram of an embodiment of a system for conducting value exchange transactions including in specific implementations, mobile person-to-person payments and transactions, mobile person-to-merchant payment transactions, and mobile banking. An applications server 107 is connected to a network 109. Although only one applications server is shown, there can be any number of applications servers in a system of the invention. Such applications servers can be executing on a single server machine or a number of server machines, which can be co-located or distributed geographically, including across various institutions.

A merchant interface 112 and a customer interface 116 are also connected to the network. This network can be any network that carries data including, but not limited to, the Internet, private networks, or virtual private networks, transported over such connections as enabled by public switch telephone network (PSTN), ISDN, DSL, wireless data networks, and many others, and combinations of these. The customer interface can handle any number of customers. The merchant interface is also connected to the applications server. Similar to the customer interface, there can be any number of merchants that connect to the application server.

On the applications server is a payment processor 119, which can also be connected to the merchant interface. A financial institution interface 123 is connected to the applications server and payment processor. There can be any number of financial institutions connected to the applications server. The applications server can also include a database 127. The database can include a system of record (SOR) 130 and virtual pooled accounts 134, which the applications server can manage. Alternatively, the SOR database can be on a separate server from the applications server and accessible to the applications server through a network or other connection. The financial institution is also connected to the database. The financial institution can manage pooled accounts 138. Therefore the system of record and virtual pooled accounts can be managed separately from the pooled accounts at the financial institution.

In an embodiment, the system of record 130 comprises functionality for maintaining real time debit, credit, history and balance for the account of each user of the system, whether merchant, individual, financial institution, etc. The SOR database can comprise a ledger account, or “T” account, for each user to facilitate tracking that user's transactions. In some embodiments, the SOR 130 also maintains a record of each user's “know your customer” (KYC) and OFAC information, together with any other appropriate identifying information. In some embodiments the SOR 130 can also include anti-fraud and security data, including velocity related data. It will be appreciated by those skilled in the art that the partial or duplicate SOR's can be maintained at the servers of various entities within the network, to provide appropriate aspects of debit, credit, history and balance information as required for that particular entity's needs. In some embodiments, the system operator is an account aggregator and becomes the system of record in terms of risk and risk control. The system operator is also responsible for performing the OFAC compliance check. The system operator can be a bank, a financial institution, an association, or can subcontract the account management to another bank.

A system of the invention can include any number of the elements shown in the figure. The system can include other elements not shown. Some elements can be divided into separate blocks, or some elements can be incorporated or combined with other elements. Additionally, some elements can be substituted with other elements not shown.

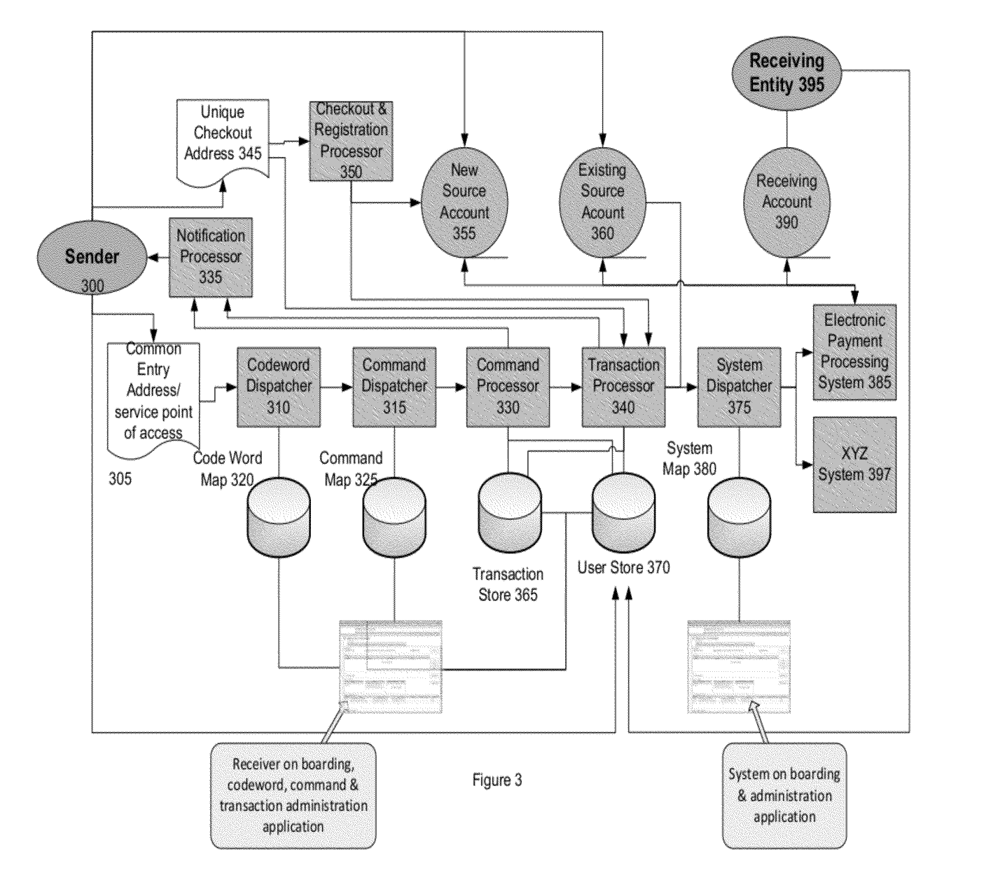

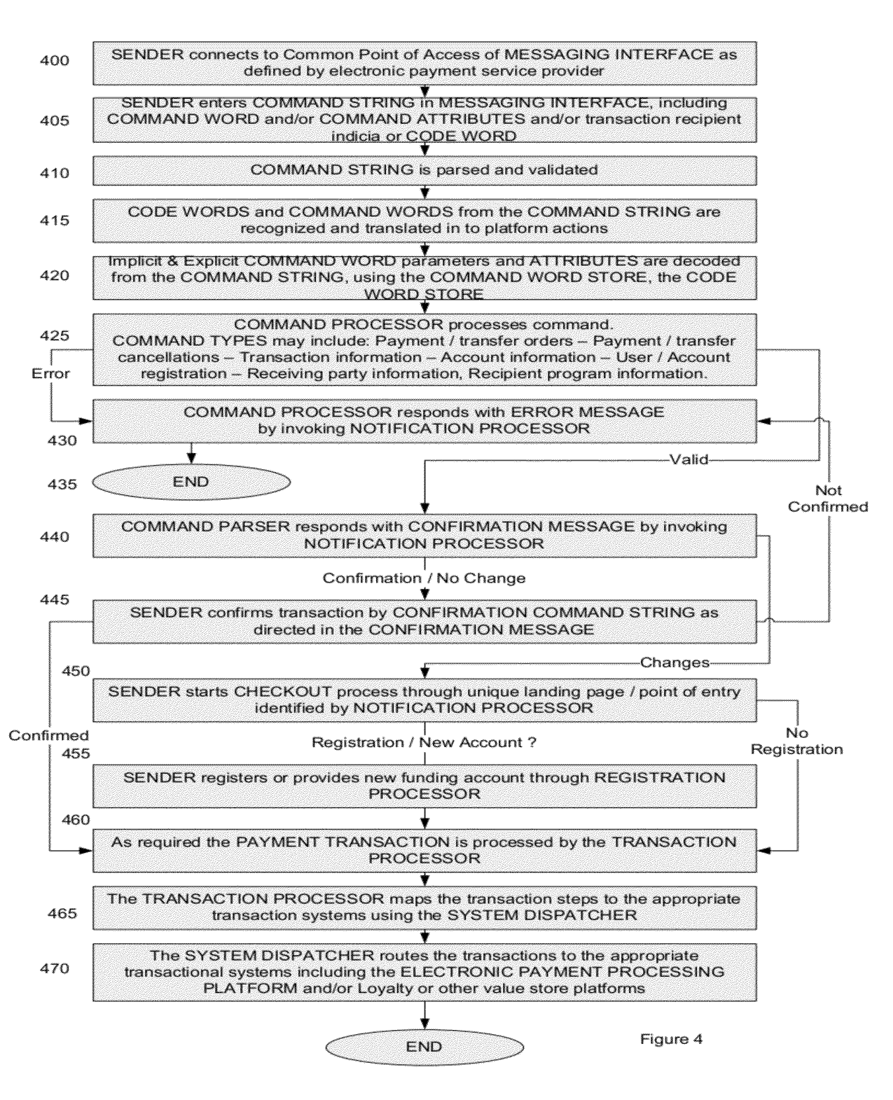

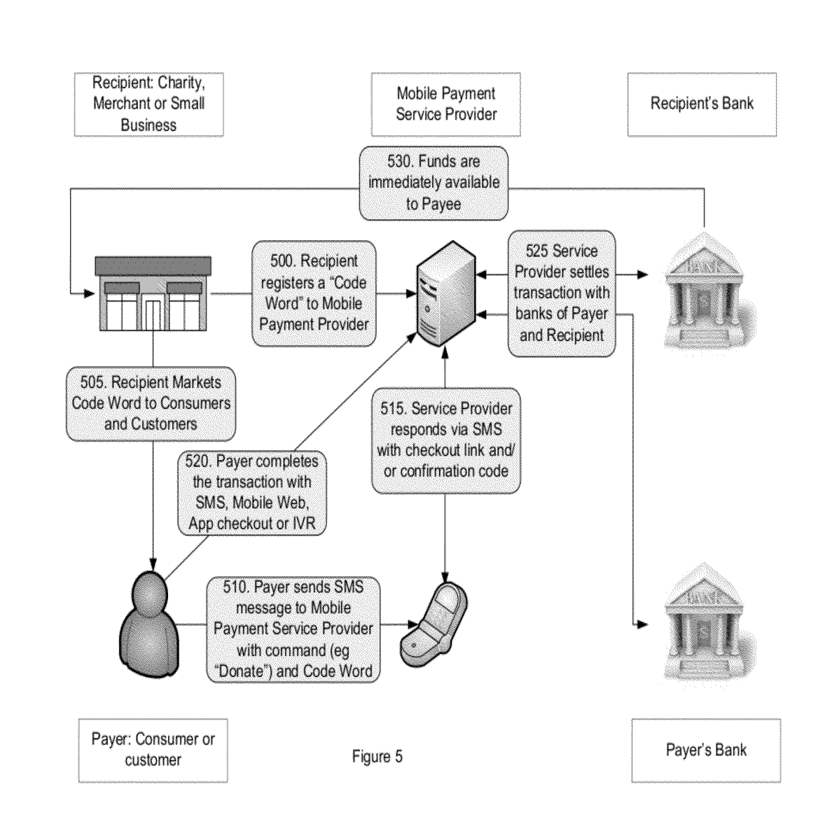

As can be better appreciated from FIGS. 3-5, the Sender 300 (FIG. 3) uses the messaging interface to send a command string with payment or payment related instructions to the electronic payment processing service provider via a service point of access using a common entry address 305, as indicated in process flow form at step 400 of FIG. 4. The command string can include a command word and, optionally, one or more associated command attributes together with a recipient indicia or code word. The command word is defined by the Electronic Payment Processing Service provider and can be any actual word, abbreviation, or character string, in English or other languages. In some embodiments, a plurality of command words can be defined to result in the same electronic payment transaction. Command words can have command attributes. Command attributes can include such parameters as, for example, the amount to pay/transfer, or a time delay before executing the transfer, or the frequency of a plurality of transfers, or a message to append to the transaction log. A command can be configured to have default or implicit attributes. For instance “Donate HaitiOutreach” may be programmed with attributes that cause it to be processed by the payment platform exactly the same as a command string saying “Donate $10 to HaitiOutreach”. In an embodiment, code words are selected and determined by Recipients and registered with the electronic payment processing service, as shown at step 500 of FIG. 5, although in other embodiments the payment processing service may provide a code word. Code words can comprise a word, a phrase, or other character string. Code words can have associated with them implicit or default command words and command attributes. For instance “MetroPCS” on its own could be defined to mean “Pay $40 to MetroPCS”. In at least some embodiments, a Sender is permitted to override implicit commands and attributes to execute different commands and functions. In an embodiment, a command string comprises a command word, followed optionally by a first separator and command attributes, followed by a second separator, followed by a code word, as shown below:

### [Command Word][1^{st} Separator][Command Attribute][1^{st} Separator] . . . [2^{nd} Separator][Code Word]

In some embodiments any number of command attributes can be included in the command string. The first separator can be a special character such as a comma, space, column, or other suitable placeholder. The second character can be a special character or a reserved word such as “to” or other suitable string.

Referring still to FIGS. 3-5, an exemplary embodiment of one arrangement of the invention in described. The Sender connects with his/her messaging interface to the service point of access, using a common entry address provided by the electronic payment service provider, as shown at step 400 of FIG. 4 and step 510 of FIG. 5. The command message entered into the messaging interface by the Sender is parsed and processed by the code word and command dispatchers 310 and 315, which interpret the command and code word and any associated command attributes according to a code word map 320 and command word map 325 included in the system of the present invention, as shown at steps 405-420 of FIG. 4. The code word map and command map may be accessed by system administration tools as required to on-board (or enroll or register) new recipients, register new code words, create new commands and generally administer transactions.

The command processor 330 executes the command as interpreted by the command dispatcher and code word dispatcher, as indicated at step 425 of FIG. 4. Command processing can include a message in response to the command string from the Sender. Example of response messages can include a confirmation of the transaction, a confirmation request for the order to perform the transaction, information about past transactions, information about recipients, or information about specific recipient programs.

Message responses from the command processor to the sender are processed and sent by the notification processor 335 when invoked by the command processor.

The command processor transfers the processing of the transaction to the transaction processor 340. The transaction processor verifies the eligibility of the user and the validity of the transaction. To the extent required by the transaction, the transaction processor may invoke the notification processor to message to the Sender, as indicated at step 430 of FIG. 4. Instances of messages to the Sender include transaction information or transaction confirmations, shown at FIG. 4, step 440. The transaction processor may require additional information from the Sender—for instance in the case of a unregistered user, as indicated generally at step 515 of FIG. 5. In such a case the transaction processor directs the Sender to a checkout process as follows. The Sender executes a checkout of the sort generally indicated at step 520 of FIG. 5 by connecting to the Unique checkout address 345 (FIG. 3) provided by the transaction processor in its response message. The checkout address can refer to a web page, a mobile web page, a wap page, an IVR number, or a specific client mobile app, and is used to connect the Sender to, and interface with, a registration and checkout processor 350.

The registration and checkout processor 350 performs such additional tasks as may be required to complete the transaction, such as the registration of a user, the registration of a new funding source, as indicated at 355, or simply information such as amounts of the transaction and authentication codes for accessing an existing funding source 360, in the process indicated at steps 440-455 of FIG. 4. Authentication codes can include PIN codes, passwords and pass phrases, security codes. Upon completion of the Registration and Checkout, the transaction processor is able to complete the transaction processing, including maintaining appropriate data stores 365 and 370, and maps the transaction steps to the appropriate transaction systems using a system dispatcher 375 and associated data store indicated as system map 380, as shown at step 460 of FIG. 4. The results of the system dispatch are provided to an electronic payment system 385 as described previously, and the funds or other forms of value are electronically “disbursed” to a receiving account 390 associated with the receiving entity 395, as shown at step 470 of FIG. 4. The result is that the service provider settles the transaction with the sender's and recipient's financial institution as indicated at step 525 of FIG. 5. In at least some embodiments the settlement is substantially in real time, as discussed previously. The output can also be provided to any other appropriate system, indicated at 397

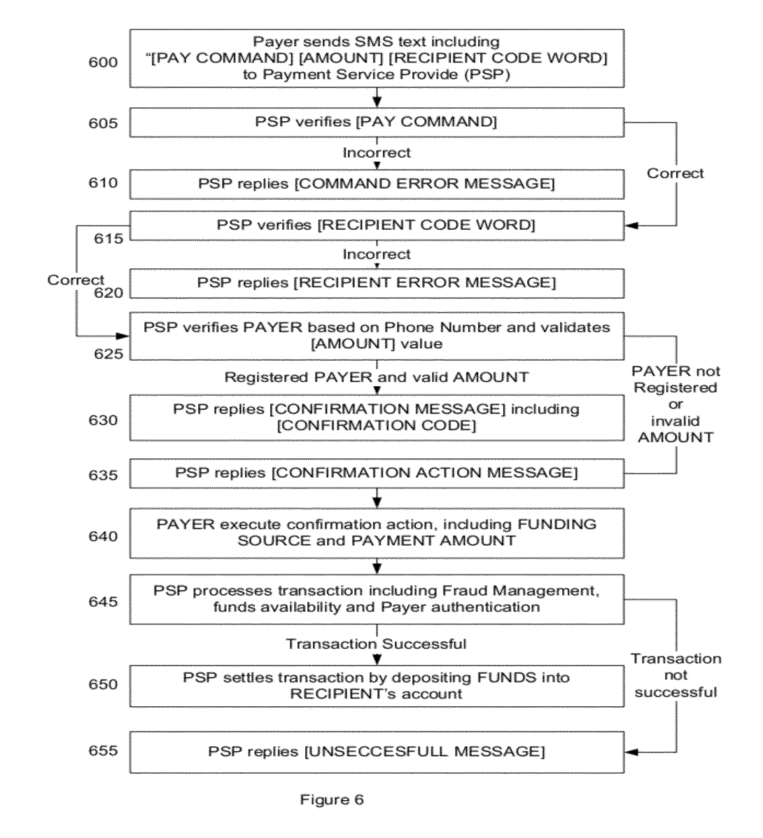

The operation of the present invention from the perspective of the payment platform can be better appreciated from FIG. 6. As shown at step 600, a payer initiates a transaction by sending an instruction via SMS or other suitable platform to the payment service provider (“PSP”). The instruction comprises, in essence, a “pay” command, an amount, and a recipient. The recipient is, in at least some embodiments, indicated by a code word. The PSP verifies the pay command as shown at step 605. If the pay command is incorrect, an error message is generated as shown at step 610. However, if the pay command is correct, the process advances to step 615, where the PSP verifies the code word that identifies at least the recipient and, in some embodiments, also identifies various default attributes such as amount, funding destination, or other data appropriate to the transaction.

If the code word is incorrect in that it does not identify a recipient, an error message is generated as shown at step 620. If the code word is correct, the process advances to step 625 and verifies the payer and the amount. If the payer is registered and the amount is valid, a confirmation message, including in some embodiments a confirmation code, is generated and sent to the sender, as shown at step 630. If the payer is not registered, or the amount is invalid, the PSP sends a confirmation message seeking appropriate action by the sender as shown at step 635.

Depending on the action required by the confirmation message, the payer executes the confirmation action, such as by identifying the source of funds, the payment amount, or other information needed to complete the transaction, all as shown at step 640. The PSP then processes the transaction including fraud management review, verification of funds availability, and any additional verification of the payer as appropriate to the transaction. If the transaction then completes successfully, the PSP settles the transaction by depositing funds into the recipient's account, as shown at step 650. If the transaction did not complete successfully, an appropriate message is generated as shown at step 655.

It will be appreciated by those skilled in the art that the invention, including the transaction processor, is capable of processing financial and non financial transactions. Examples of non financial value exchange transactions include the transfer of loyalty points to a third party, for instance for charity purposes. In as much as the execution of a transaction must be split between different processing systems, the transaction processor invokes a system dispatcher as shown in FIG. 3, which routes transactions to the appropriate transaction processing systems.

One such transaction processing system is the electronic payment platform described as part of the present invention.

The following describes an embodiment of the system of the present invention used for transferring funds for the purpose of a charitable donation.

Financial transactions can be conducted by individuals registered or not, interacting with entities having registered an account with the electronic payment service provider. Registered sending individuals are identified by their phone numbers, or financial account while registered receiving entities are identified by a unique code word of their choice. Receiving entities may be any of individuals, merchants, charitable institutions.

In one embodiment registered senders may maintain one or a plurality of funding accounts any one or more of which they may use to fund a transaction. Funding accounts can be held with the electronic payment service provider in the form of a prepaid account, or with third party financial services providers. Accounts can include checking accounts, credit accounts, debit accounts and prepaid accounts whether in a private currency or not. When the user desires to conduct a transaction the account are accessed by the electronic payment service provider to validate funds availability and to conduct settlement with the account holding institution of the receiver.

In one embodiment unregistered users may use the system by entering their chosen funding account references during the checkout process.

In at least some implementations of the invention, in order to receive funds with the electronic payment processing service where the sender identifies the recipient by a code word, receiving entities must register with the electronic payment processing service provider. In an embodiment, registration requires that the recipient provide information sufficient to identify at least one account into which transaction funds can be deposited, such as a demand deposit account, a debit account or a prepaid debit account. Alternatively the receiving entity may sign up for a prepaid debit account with the electronic payment service provider. Registration further requires that the receiving entity submits to the necessary checks for Fraud Management purposes and compliance with the financial regulations in place (such as Anti Money Laundering). At registration, the receiving organization also chooses one or a plurality of Code Words, that Senders may utilize to identify the receiving entity as the recipient of funds in a transaction. In one embodiment of this invention the receiving entity may be a person and the Code Word may be a mobile phone number or email. In at least some embodiments, the code words uniquely identify a recipient, although the code word(s) need not be unique to a particular campaign in all instances.

In one embodiment of the present information Receiving parties may also provide to the Electronic Payment Processing service providers additional information on themselves, or on the program associated to the transaction to respond to queries by the Senders. Receiving parties also may determine the processing terms for the transaction and in particular whether they wish to receive funds immediately.

Receiving entities are then able to provide the Senders with the Code Word to use in a transaction. This can be done via a variety of communication methods such as mail, email, print media, display media, Video or Audio advertising. In one embodiment of the present invention the Receiving entity may display its Code Word at the location and point where it provides services to a Sender which then uses its mobile phone and the electronic payment processing service to provide payments to the Receiving entity at the time the Sender receives services. A unique aspect of the present invention is the ability of the Electronic Payment Processing service to receive a transaction, process a payment and deposit funds into the account of the Receiving entity in real time, thus enabling commercial transactions. Through the use of such an arrangement, the present invention is superior to other existing solutions where receiving entities must obtain a short code from a mobile operator or an intermediary, a complex, lengthy and expensive process. In addition Receiving entities may utilize a plurality of Code Words targeted for use by different Senders, or different occasions, thus multiplying the marketing and data mining opportunities offered by the system of the present invention.

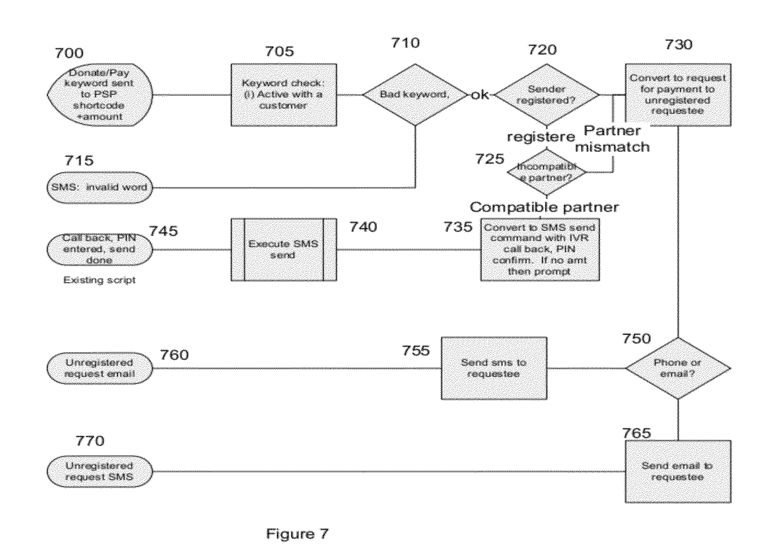

Equipped with the knowledge of the Code Word of the intended receiving entity of a transaction, the Sender is able to send any amounts of money to the receiving party, subject to such limits as may be required for fraud prevention or currency transfer rules. This is accomplished by the Sender sending to the Electronic Payment Processing service provider a short message with a command word and command attributes, and code word, such as shown at 700 in FIG. 7. Exemplary embodiments of Command Word would be “Pay” or “Donate” or “Transfer” or “Send_Money” or “Cash”. The amount may be any sum defined by the Sender. In addition in one embodiment of the present invention the Command Word may be refer to specific or default Amount. For instance “DonateNow HaitiRelief” may have the same meaning as “Pay $25 HaitiRelief, where HaitiRelief” is the Code Word of the receiving entity. In yet another embodiment of the present invention a Command Word may be explicitly created for a program and linked to a particular receiving organization. For instance “DonateHaiti” may have the same significance as “Pay now $19 to Haitioutreach”. The system of the present invention is thus superior to pre-existing solution in that it allows a variety of command words to be defined and concurrently supported and that any amounts may be transacted over the system, rather than only a limited number of pre-determined amounts. Thus the present invention is distinguished from the prior art by, among other things, its ability to allow recipients to define and execute evolved campaigns.

As illustrated in FIG. 7, the keyword is checked at step 705 by the system of the present invention, which also checks the remaining steps in the process. If the keyword is not active with a recipient, an error message is sent as shown at step 715. However, if the keyword is valid, the process advances to step 720, where the system checks to determine whether the sender is registered. If the sender is registered, then in some embodiments a check is made at 725 to determine whether the financial partner associated with the sender has authorized its customers to participate in the type of transaction requested by the sender.

If the sender is not registered, as determined at step 720, the process converts to a request for payment from an unregistered payer, as shown at step 730 and discussed further hereinafter.

If the financial partner is determined to be compatible as shown at step 735, then, in some embodiments, a message is generated requesting an IVR callback to provide confirmation or, if no donation or payment amount was specified, to prompt the sender to enter the necessary data. Any suitable confirmation method is acceptable, such as a PIN or other authentication indicia. The sender then executes the confirmation as indicated at step 740, such that the callback is completed and the sending of funds done as shown at step 745.

If the sender is not registered, the indicia used to identify the sender, such as phone number, email address or other identifier, is determined at step 750. If the phone number is known, a request for the sender email address is sent as shown at steps 755 and 760. Similarly, if the sender's email address is known, an email request for the sender's phone number is sent, as shown at steps 765 and 770.

In one embodiment of the present invention the Electronic Payment Processing platform is capable of processing information commands, providing either information on the service, or information on the intended recipient of the funds (“Haiti Outreach”), or information on the program associated with the transaction (“Haiti-telethon”) or information on previous transactions completed by the Sender.

Upon receiving an Electronic Payment Processing message, the system of the present invention determines whether the sender is a registered user or not.

Registered Senders may complete their transaction with a simple confirmation procedure, whereby the Electronic Payment Processing service provider replies to the Electronic Payment Processing message with a Confirmation Code, or, optionally, a Confirmation Link and a request for Sender authentication. The Sender may use the confirmation code in any number of confirmation methods either through the messaging interface used to initiate the transaction or through other methods such as a web page or a mobile app or a call to an IVR/automated voice response system, as designated in the Confirmation Link. The Sender uses the Confirmation Code in the event the Confirmation Method uses a different messaging interface, to avoid a break in the Payment Processing command flow. In one embodiment of the present invention, the sender may also receives the Confirmation Code as part of a request for payment message. The Sender authentication method may comprise one or a plurality of Authentication Methods including something the Sender knows (such as a PIN CODE or PASSWORD), and/or something the Sender owns (such as the serial number or IMIE number or phone number, and/or something the Sender is (such as a biometrics data capture). In one embodiment of the present invention, multiple authentication methods are required to confirm the transaction to ensure high levels of security. Upon confirmation of the identity of the Sender, funds are then debited from the Funding Account defined by the registered Sender and processed by the Electronic Payment Processing service. The present invention is unique compared to existing solutions in that it enables a confirmation of the transaction through a variety of different Sender interfaces, leveraging the most convenient and secure methods required by the Electronic Payment Processing service provider and/or the Receiving entity. Thus transactions are confirmed positively to avoid subsequent disputes. In addition support for multiple methods of authentication of the Sender not only prevents fraud but also enables higher standards of auditability of the transactions.

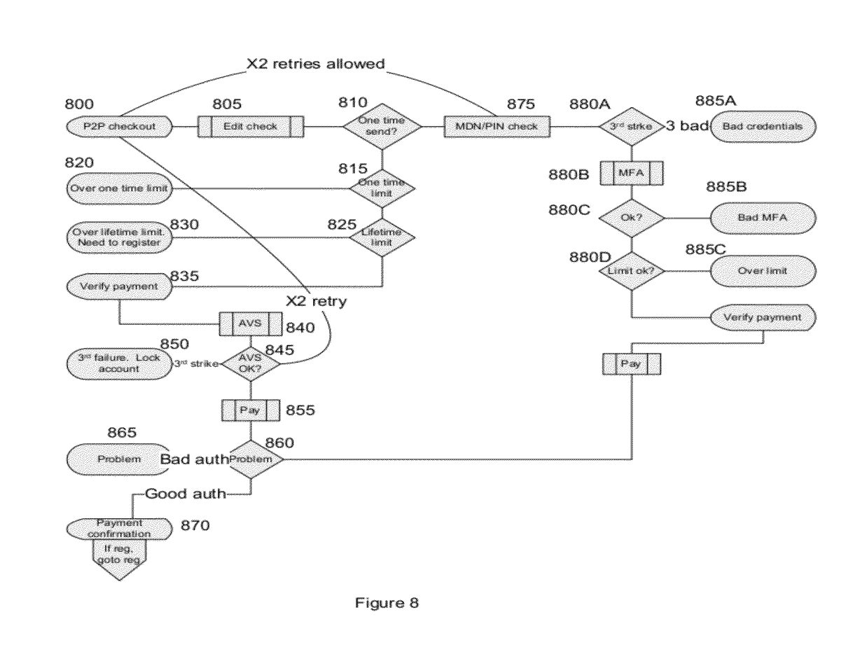

Unregistered Senders may complete the transaction by proceeding through a linked checkout process, such as shown in FIG. 8. The Electronic Payment Processing platform, having determined that the Sender is not registered, responds to the Electronic Payment Processing message with Confirmation Method link and optionally a confirmation code. The Sender is thus directed to a checkout process that will capture his or her funding account, a confirmation of the amount to process, the confirmation code sent by the Electronic Payment Processing platform and any personal information as may be required to confirm the availability of funds with the entity holding the funding account of the Sender. Upon validation of the funding information of the Sender, the Electronic Payment transaction is processed by the Electronic Payment Processing platforms. Thus the system of the present invention is superior to any current solution in that it allows any user—registered or not with the Electronic Payment Processing service provider—to participate to a transaction. Various other verifications can also be performed in at least some embodiments, including limits on the size of a one-time transaction, lifetime limits on the sum of a plurality of transactions. Likewise, multifactor authentication is used in some embodiments. Thus, referring to FIG. 8, when a sender is referred to checkout, the process begins at 800. The request is then checked to determine whether the amount exceeds either a one time limit or a lifetime limit on the amount of funds that can be transferred before registration is required, as indicated at steps 805-830. If the request passes the various checks, the payment source is then verified as shown at steps 835-850, where a lockout occurs if authentication fails a plurality of times, such as three failures. Payment is then checked at step 855 and, if no problem is found at step 860, payment is confirmed at step 870. If a problem is found, an error message is sent at step 865.

An MDN/PIN check is also performed in at least some embodiments, as indicated at step 875. If the wrong PIN is entered a plurality of times, such as three, or the Multifactor Authentication (MFA) fails, or an overlimit occurs, as checked and indicated at steps 880A-885C, then the transaction fails. However, If each of the checks completes satisfactorily, payment is then verified at shown at step 890 and payment is made at step 895. A plurality of retries can be permitted if steps 845 or 875 are not completed successfully, as shown by the loop back to step 800.

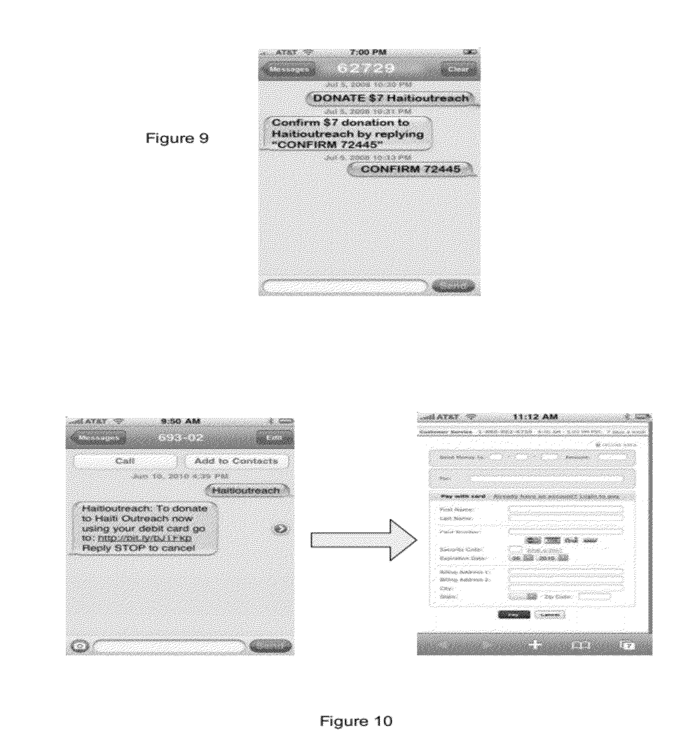

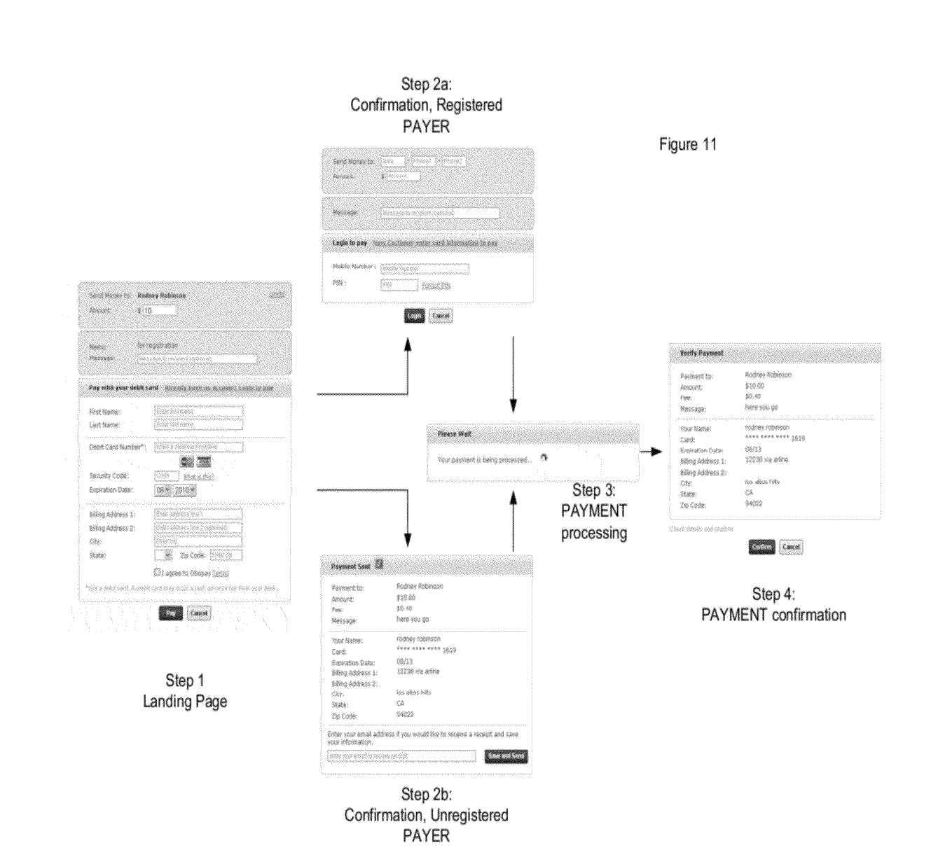

FIGS. 9, 10, and 11 illustrate exemplary embodiments of the mobile phone messages and checkout pages for registered and unregistered users. Thus, FIG. 9 shows an embodiment of the messages exchanged with a registered user, whereas FIG. 10 shows an embodiment of phone messages and checkout page for an unregistered user, while FIG. 11 shows an exemplary embodiment of the checkout procedure for mobile web or mobile application cases.

Registered User may chose to use the linked confirmation/checkout process to select other forms of payment and/or funding accounts as may be designated in their registration. The system of the present invention is therefore distinguished from any current payment platforms as it allows the selection of a plurality of funding source for any given transaction at the discretion of the Sender, in effect increasing the transaction opportunities for the Receiving party.

In one embodiment of the present invention the Electronic Payment platform sends to the Sender a transaction confirmation message or alternatively a transaction failure message.

When processing the transaction, the Electronic Payment Processing platform performs a number of functions such as transaction velocity checking as well as user and device authentication, to identify any potential fraudulent transactions, fee processing and collection for the transaction processed. The Electronic Payment Processing platform then settles and clears the transaction generating funds transfer commands to the appropriate financial network depending on the settlement terms of the transaction (real time or delayed). Settlement of the transaction and transfer of the funds processed may be on a real time or delayed basis according to the selection of the Receiving entity and the funding source and method used by the Sender. The system of the present invention by integrating a Payment message module with a payment processing module with a settlement module is distinguished from present solutions by the flexibility it provides to the recipients to select the terms (availability of funds) and costs (transaction service fees) best suited to their needs or the need of a specific program.

In addition to processing transactions, the Electronic Payment Processing service provider maintains such information as may be needed for the purpose of support Customer Support inquiries, transaction dispute processes in accordance to the rules associated with the funding accounts, and any inquiries required by regulations or compliance programs. A large number of new products and services will benefit from the present invention. For example, any device capable of communicating wirelessly and through a simple message interface with the Electronic Payment Processing service may be used to practice the present invention. Such include devices used in the context of Instant Messaging over wireless protocols.

It will further be appreciated that one or more of the elements depicted in the drawings or figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, further embodiments can include various alternative indicia in lieu of the Code Word, such as unique bar codes scanned by Sender. The cell phone can be any communication device that is portable and capable of connecting to a data network through at least one instant messaging interface and protocol.

Additionally, any signal arrows in the drawings or figures should be considered as only exemplary, and not limiting, unless otherwise specifically noted. Furthermore, the term “or” as used in this application is generally intended to mean “and/or” unless otherwise indicated. Combinations of components or steps will also be considered as being noted, where terminology is foreseen as rendering the ability to separate or combine is unclear.

As used in the description in this application and throughout the claims that follow, “a,” “an,” and “the” includes plural references unless the context clearly dictates otherwise. Also, as used in this description and throughout the claims that follow, the meaning of “in” includes “in” and “on” unless the context clearly dictates otherwise.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A method managing a value exchange comprising the steps of
providing a messaging interface having a common point of access,
receiving at the messaging interface an encoded message having a command string comprising at least one of a command group comprising command word, command attributes, code word, or recipient indicia,
parsing and validating the command string,
translating the at least one of the command group, and
executing the value exchange.
